(19) United States
(12) Patent Application Publication
(10) Pub. No.: US 2019/0160844 A1
(43) Pub. Date: May 30, 2019

(54) DIGITAL PRINTING ON A TEXTURED WOOD-BASED SUBSTRATE

(71) Applicant: LOUISIANA-PACIFIC CORPORATION, NASHVILLE, TN (US)

(72) Inventor: BEN SKOOG, NASHVILLE, TN (US)

(21) Appl. No.: 16/197,596

(22) Filed: Nov. 21, 2018

Related U.S. Application Data
(60) Provisional application No. 62/588,954, filed on Nov. 21, 2017.

(51) Int. Cl. B41M 5/00; B41M 1/38

(52) U.S. Cl. CPC B41M 5/0076; B41M 1/38

(57) ABSTRACT

A system and related methods for high-resolution digital printing on textured wood-based substrates, including, but not limited to, plywood, wood planks, oriented-strand board (OSB), laminated strand lumber (LSL), laminated veneer lumber (LVL), paper board, and various forms of engineered wood. A high resolution scan of the board or image to be duplicated is obtained and stored electronically. It may be modified with the addition of custom images. The image is then printed on one or more substrates in a production line. Physical texture and depth may be added by varying the thickness of the ink applied.

This application claims benefit of and priority to U.S. Provisional App. No. 62/588,954, filed Nov. 21, 2017, which is incorporated herein by specific reference for all purposes.

### FIELD OF INVENTION

This invention relates to a system and related methods for digital printing on a textured wood-based substrate, including but not limited to engineered wood.

### SUMMARY OF INVENTION

In various exemplary embodiments, the present invention comprises a system and related methods for high-resolution digital printing on textured wood-based substrates. Textured wood-based substrates include, but are not limited to, plywood, wood planks, oriented-strand board (OSB), laminated strand lumber (LSL), laminated veneer lumber (LVL), paper board, and various forms of engineered wood. The present invention allows the high quality duplication of the aesthetic and textural features of a particular type or style of board or panel on the substrate.

In several embodiments, the initial step is obtaining a high resolution scan of the board or image to be duplicated. The scan data is stored in an electronic data file, as known in the prior art. The scanned image can be modified, if desired, including, but not limited to, the addition of custom foreground or background images. The scanned image is not limited to wood, and any material or image can be replicated on the substrate. The image, modified or unmodified, is then printed on one or more substrates in a production line using a large-scale production printer. The printing duplicates the image and also can add texture and depth, based on the thickness of ink applied. The thickness of the ink may correspond to the high and low areas on the original board being duplicated, thereby matching the texture and feel of the original board as well as the appearance.

In one embodiment, the substrates are in the form of planks, and the image is scaled in size (increased or decreased) in one or more dimensions to correspond to the size of the planks. The image may also be cropped to fit the dimensions of the planks.

In several embodiments, the substrate is prepared specifically for printing, including the use of a light color (e.g., white) primer on the surface being printed. The substrate may be of any desired size. In one embodiment, the substrate comprises a board 54 inches long, which assists in minimizing warping of the printed product. During printing, the substrate should be as flat as possible. In addition, the variance in thickness of the substrate can be decreased, such as by sanding or planning the back of the substrate. This allows for a higher resolution in printing.

### BRIEF DESCRIPTION OF THE DRAWINGS

FIG. 1 shows a view of a system in accordance with an exemplary embodiment of the present invention.

FIG. 2 shows another view of an alternative embodiment of the present invention.

FIG. 3 shows another view of an alternative embodiment of the present invention.

### DETAILED DESCRIPTION OF EXEMPLARY EMBODIMENTS

In various exemplary embodiments, the present invention comprises a system and related methods for high-resolution digital printing on textured wood-based substrates. Textured wood-based substrates include, but are not limited to, plywood, wood planks, oriented-strand board (OSB), laminated strand lumber (LSL), laminated veneer lumber (LVL), paper board, and various forms of engineered wood. The present invention allows the high quality duplication of the aesthetic and textural features of a particular type or style of board or panel on the substrate.

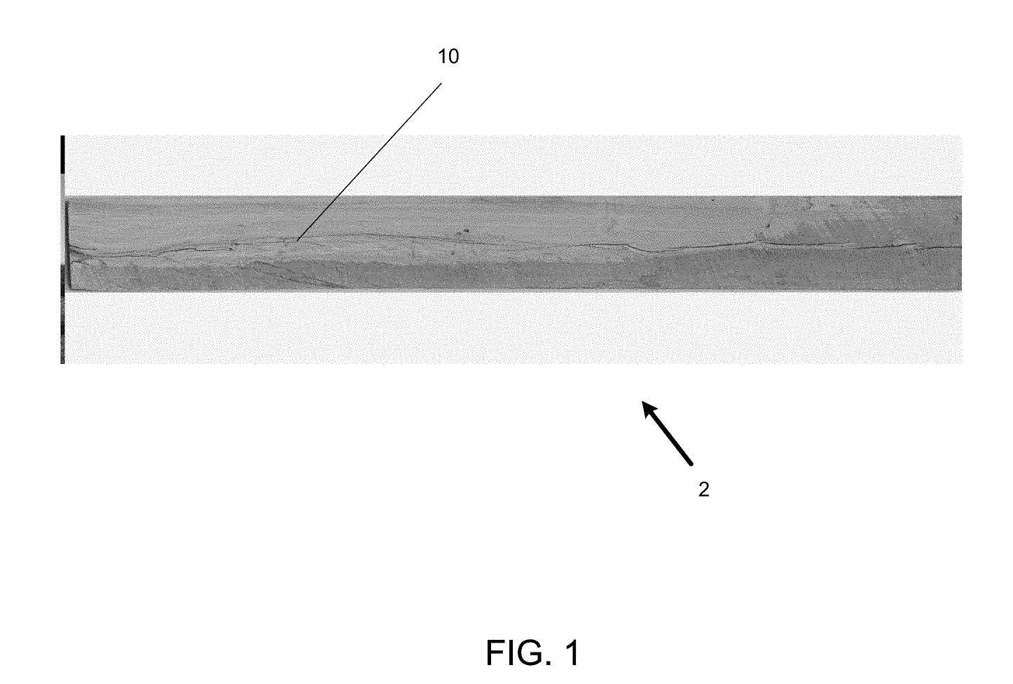

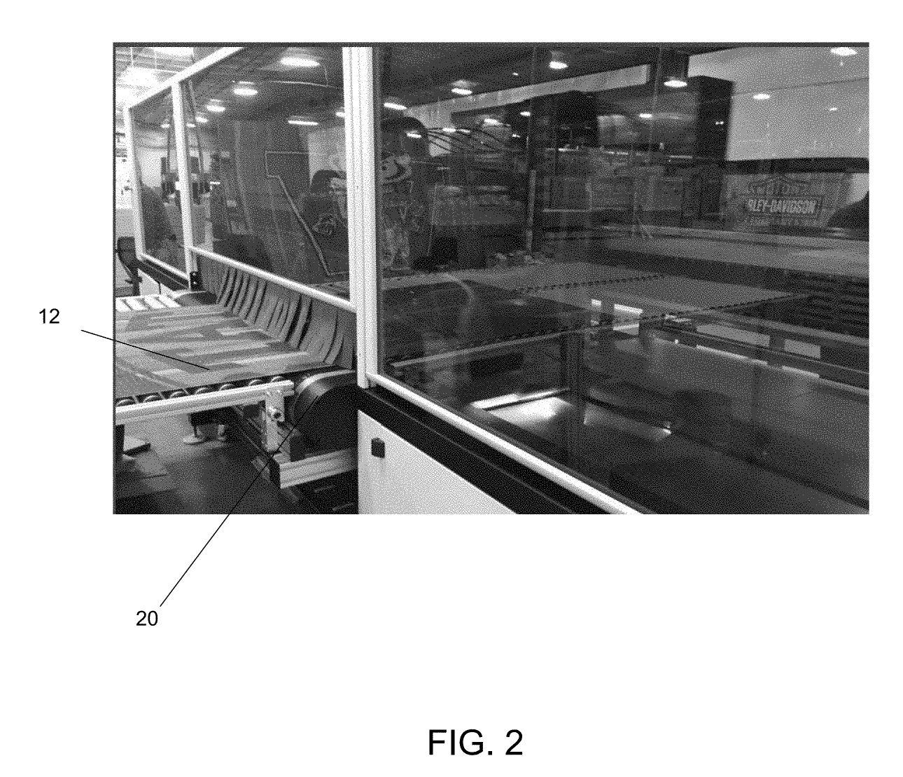

In one embodiment, the initial step is obtaining a high resolution scan of the board or image to be duplicated. FIG. 1 shows an example of a high resolution scan 2 of an aged board 10 from a barn (i.e., “barnwood”). The scan data is stored in an electronic data file, as known in the prior art. The scanned image can be modified, if desired, including, but not limited to, the addition of custom foreground or background images 12 (as seen in FIG. 2). The scanned image is not limited to wood, and any material or image can be replicated on the substrate.

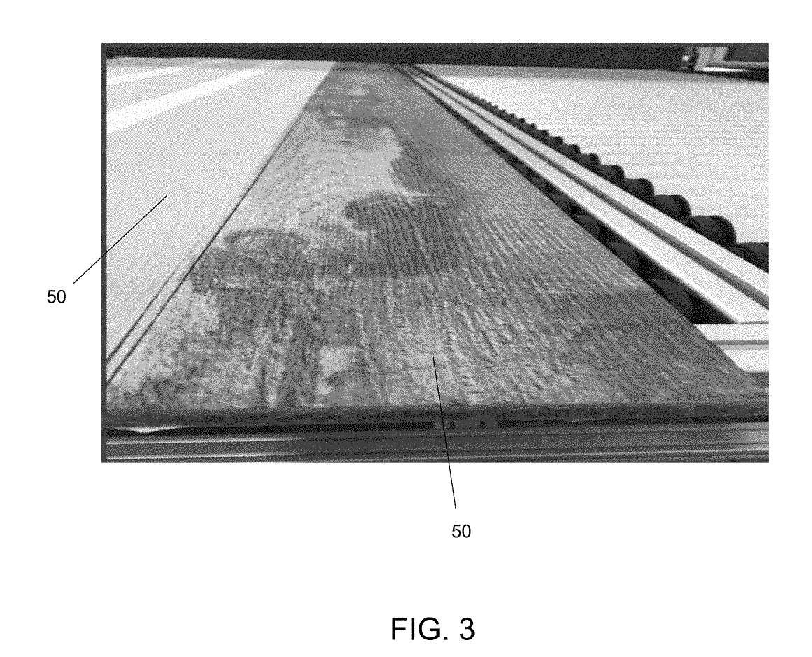

The image, modified or unmodified, is then printed on one or more substrates in a production line using a large-scale production printer 20, as seen in FIG. 2. The printing duplicates the image and also can add texture and depth (as seen in FIG. 3), based on the thickness of ink applied.

In one embodiment, the substrates are in the form of a plank, and the image is scaled in size (increased or decreased) in one or more dimensions to correspond to the size of the plank. The image may also be cropped to fit the dimensions of the plank.

In several embodiments, the substrate is prepared specifically for printing, including the use of a light color (e.g., white) primer on the surface being printed. The substrate may be of any desired size. In one embodiment, the substrate comprises a board 54 inches long, which assists in minimizing warping of the printed product. During printing, the substrate should be as flat as possible. In addition, the variance in thickness of the substrate can be decreased, such as by sanding or planning the back of the substrate. This allows for a higher resolution in printing.

FIG. 3 shows a comparison of the unprinted textured manufactured wood substrate 40 on the left, with an example 50 of the same type of substrate printed in accordance with the above method. The finished product may be specially packaged.

Accordingly, the present invention allows for the duplication of limited or rare material, such as weathered barn wood planks, thereby removing supply chain limitations around procurement of scare and limited material.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of duplicating the appearance of a board on a manufactured wood substrate, comprising:
obtaining a high resolution scan of the board to be duplicated;
storing the board scan data in an electronic data file;
providing one or more manufactured wood substrates; and
printing, using a large scale production printer, the board scan data in ink on a surface of said one or more manufactured wood substrates.

2. The method of claim 1, wherein the board is an aged or weathered barn board.

3. The method of claim 1, wherein the board scan data is modified after scanning.

4. The method of claim 1, wherein the board scan data is modified by adding a foreground or background image to the board scan data.

5. The method of claim 1, wherein the board scan data is printed on a plurality of manufactured wood substrates.

6. The method of claim 5, wherein the manufactured wood substrates are in the form of a plank, and the board scan data is scaled in size to correspond to the dimensions of the plank.

7. The method of claim 1, wherein the thickness of the ink is varied.

8. The method of claim 1, wherein the variations in thickness correspond to high and low points in the board being duplicated.

9. The method of claim 1, wherein comprising the step of priming the surface of the substrate before printing.

10. The method of claim 1, wherein multiple surfaces of the substrate are printed.

11. The method of claim 1, wherein multiple surfaces of the board are scanned, with each board surface scan data stored in an electronic data file

12. A manufactured wood board with the appearance of an aged or weather board, manufactured according to the method of claim 1.

13. A manufactured wood board product, comprising:
a manufactured wood substrate with at least one surface;
a high resolution scanned image of aged or weathered board printed in high definition on said at least one surface;
wherein the printed image is varied in thickness to correspond to high and low features in the aged or weathered board;
wherein the aesthetic and textural features of the aged or weathered board are duplicated on the substrate surface.
